(19) United States
(12) Patent Application Publication
(10) Pub. No.: US 2009/0102401 A1
(43) Pub. Date: Apr. 23, 2009

(54) SOLID-STATE LIGHTING NETWORK AND PROTOCOL

(75) Inventor: Ian Ashdown, West Vancouver (CA)

Correspondence Address: PHILIPS INTELLECTUAL PROPERTY & STANDARDS, 3 BURLINGTON WOODS DRIVE, BURLINGTON, MA, 01803, US

(73) Assignee: TIR TECHNOLOGY LP, Burnaby, BC (CA)

(21) Appl. No.: 12/297,724

(22) PCT Filed: Apr. 20, 2007
(86) PCT No.: PCT/CA07/00673

§ 371 Date: Oct. 20, 2008

Related U.S. Application Data
(60) Provisional application No. 60/814,613, filed on Jun. 15, 2006.

(30) Foreign Application Priority Data
Apr. 21, 2006 (CA) 2544479

(51) Int. Cl. H05B 37/00

(52) U.S. Cl. 315/312

(57) ABSTRACT

The present invention provides a solid-state lighting network with one or more master controllers and one or more nodes which are interconnected by an interconnect system. The one or more nodes and the one or more master controllers are configured to generate messages and exchange the messages via the interconnect system. Each message comprises a message code and optional parameters.

### FIELD OF THE INVENTION

The present invention pertains to the field of lighting and in particular to the control of lighting networks.

### BACKGROUND

Two lighting network interconnect systems which are widely used today are DMX512A and the Digital Addressable Lighting Interface (DALI). DMX512 was developed in the 1980s for control of stage lighting and DALI was developed in the 1990s for fluorescent lamp control. DMX512 uses RS-485 and DALI operates on proprietary hardware. Lighting technology, however, has progressed tremendously over the past decade and neither of these two interconnect systems easily facilitates general-purpose lighting control at a level desirable for solid-state lighting. Both interconnect systems are very closely tied to their hardware layer specifications, and, while providing flexible command definitions, are limited to a rigorous addressing and message format.

Other interconnect systems rely on components from proprietary and open technology. Widely known industry-standard interconnect systems are BACnet (see www.bacnet.org), BitBus (see www.bitbus.org), CANbus (see www.canbus.us), KNX (see www.konnex.org), LonWorks (see www.longmark.org) ModBus (see www.modbus.org) or X10 (see www.x10.org), for example. These interconnect systems are well-suited for certain building or industrial site management applications and even for specialized home automation applications. They are feature rich and have been used with varying success to implement general lighting control networks but have not been found to provide cost effective solid-state lighting control interconnect system solutions. Remote control of solid-state lighting devices with existing general purpose interconnect systems is complicated and cost-ineffective.

One such system is described in the “BITBUS™ interconnect serial control bus specification”, order number 280645-001 as published by Intel Corporation, 1988, which is herein incorporated by reference. Interconnect systems have also been described in the patent literature.

For example, U.S. Pat. No. 5,726,644 describes a lighting control system with packet hopping communication. The system can be used for building lights that are master controlled to reduce power consumption under building master control, or in response to electric utility commands to the building computer. Each lighting wall control unit includes a transceiver which can communicate to at least one neighbour transceiver, thereby forming a distributed communication network extending back to the building computer. The transceivers operate asynchronously with low data rate FSK signals, using carrier frequencies between 900 and 950 MHz. Different communications protocols control packet forwarding and acknowledgement so that messages reach their destination but are not forwarded in endless circles thereby potentially reducing collisions. This interconnect system, however, is configured to submit commands for the control of one parameter to all of the device control units.

U.S. Pat. No. 6,175,771 describes a lighting communication architecture which provides different kinds of controlling options. A single channel per line communication is described, wherein this can be used to form single channel DMX to communicate with DMX format luminaires, while still using only one communication per line. The controlling console has a single connector that outputs information for all luminaires. This is connected to a distribution rack, which itself includes plural connectors but spaced from the console. The multiple connectors can represent communications in many different formats including formats of one lamp per line, or time division multiplexed formats of many lamps per line. The patent describes interconnect architectures on a physical layer level but does not specify instructions or details of instruction encoding.

U.S. Pat. Nos. 6,664,745, 6,570,348, 6,459,217 and 6,331,756 describe methods and an apparatus for digital communications with multi-parameter light fixtures. It is further described that a typical light fixture is an integral unit that has a lamp assembly and a communications node to control the lamp assembly and that a lighting system contain many such light fixtures. One type of lighting system has at least two communication systems that interconnect the light fixtures. A digital controller is connected to one of the communication systems, at least one of the light fixtures of that communication system is a designated gateway for sending control signals to the other communication system. Another type of lighting system has two digital controllers connected to respective communication systems. Each of the communication systems interconnects many light fixtures, at least one of which has two communication nodes respectively connected to the communication systems. A third type of lighting system mixes the first and second types. These patents describe interconnect architectures on a physical layer level but do not specify instructions or details of instruction encoding. Thus there is a need for a new solid-state lighting interconnect system.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a solid-state lighting network and protocol. In accordance with an aspect of the present invention, there is provided a solid-state lighting network comprising one or more master controllers and one or more nodes, and an interconnect system operatively coupling the one or more master controllers to the one or more nodes, wherein the one or more nodes and the one or more master controllers are configured to generate messages and exchange the messages via the interconnect system, and wherein each message comprises a number of parameters and one of one or more command codes.

In accordance with another aspect of the present invention, there is provided a solid-state lighting network control method comprising generating messages, with each message comprising a number of parameters and one of one or more command codes, and communicating the messages via an interconnect system.

### BRIEF DESCRIPTION OF THE FIGURES

FIG. 1 illustrates a solid-state lighting network according to one embodiment of the present invention.

FIG. 2 illustrates a table of commands for a solid-state lighting interconnect system according to an embodiment of the present invention.

FIG. 3A illustrates the first part of a table of commands for a solid-state lighting interconnect system according to an embodiment of the present invention.

FIG. 3B illustrates the second part of the table illustrated in FIG. 3A.

FIG. 4 illustrates a table of commands for a solid-state lighting interconnect system according to an embodiment of the present invention.

FIG. 5 illustrates a state machine for processing commands according to one embodiment of the present invention.

FIG. 6 illustrates a state machine for processing transmitted commands according to one embodiment of the present invention.

### DETAILED DESCRIPTION OF THE INVENTION

### Definitions

The term “light-emitting element” (LEE) is used to define a device that emits radiation in a region or combination of regions of the electromagnetic spectrum, for example, the visible region, infrared or ultraviolet region, when activated by applying a potential difference across it or passing an electrical current through it. Light-emitting elements can have monochromatic, quasi-monochromatic, polychromatic or broadband spectral emission characteristics. Examples of light-emitting elements include semiconductor, organic, or polymer/polymeric light-emitting diodes (LEDs), optically pumped phosphor coated LEDs, optically pumped nano-crystal LEDs or other similar devices as would be readily understood. Furthermore, the term light-emitting element is used to define the specific device that emits the radiation, for example a LED die, and can equally be used to define a combination of the specific device that emits the radiation together with a housing or package within which the specific device or devices are placed.

The term “solid-state lighting” is used to refer to a kind of lighting that employs electroluminescent light sources such as for example light-emitting elements.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides an interconnect system for controlling a solid-state lighting network. The lighting network comprises one or more master controllers, one or more nodes and an interconnect system. Tasks operate on both the master controller and the nodes, which can be implemented in software or firmware, which can be processed by a computing device or processor associated with each thereof. A master control program can be operated within each master controller. The master control program comprises certain tasks which, based upon user input, generate and control the submission of messages via the interconnect system. The nodes can receive messages and tasks within the nodes can process the messages. Certain tasks within each node can respond to the received messages and may, depending on the type of the message, submit response messages back to the master controller(s) via the interconnect system. In this manner the message system can be used to implement commands of a solid-state lighting network protocol.

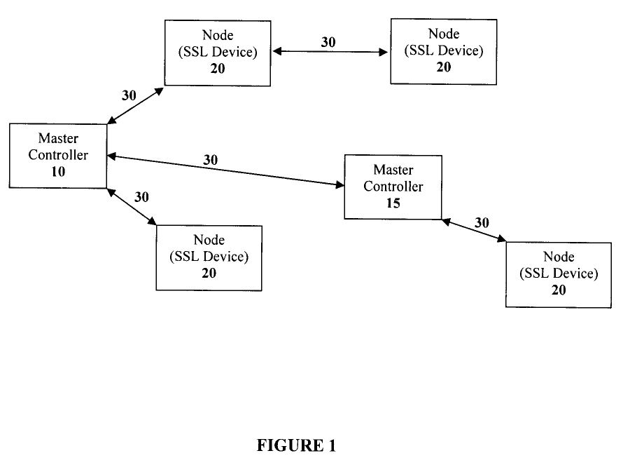

FIG. 1 illustrates a lighting network according to one embodiment of the present invention. The lighting network comprises master controllers 10 and 15, which via an interconnect system 30 are connected to one or more nodes 20, wherein for this embodiment each node is a solid-state lighting device. As illustrated, master controller 10 can provide control messages over the interconnect system 30 to multiple nodes and optionally as illustrated to master controller 15. In addition, in some embodiments of the present invention, as illustrated in FIG. 1, nodes can forward messages therebetween also via the interconnect system.

Each message comprises a message code indicating whether the message is a command or a response to a command. Command messages can originate from the master controller(s), whereas response messages can originate from nodes. The data in messages is controlled by tasks within a respective master controller or node.

Generally node tasks, i.e. tasks within a node, are intended to act upon commands encoded within messages received from the master controller(s) to control the operating conditions of the node. Nodes can comprise lighting devices such as luminaires or fixtures which can comprise one or more solid-state or non-solid state lighting devices or actuators, for example. The operating conditions of a node can include luminous flux and chromaticity of emitted light generated by a lighting device or the orientation of the lighting device, for example.

### Interconnect System

The unique requirements of solid-state lighting can be met by an adequately structured interconnect system of proper topology. The interconnect system can support a wired or wireless network, the configuration of which would be readily understood by a worker skilled in the art. The interconnect system provides a degree of interconnectivity that is sufficient to be able to support exchange of messages between the master controller(s) and the nodes. The interconnect system may exchange messages directly between the master controller(s) and the nodes or some or all nodes or master controller(s) may relay messages to other nodes and master controllers.

In one embodiment of the present invention, the interconnect system can be fully interconnected such that each one of the nodes or master controller(s) or both can directly communicate with any one of the other nodes or master controller(s) or both. For example, nodes that utilize wireless networks are fully interconnected on a physical layer with all other nodes within the range of the respective carrier signals. Wireless networks according to the present invention can utilize different bands of electromagnetic radiation such as visible, infrared, microwave or radio frequencies. As is well known, certain types of wired buses may also provide full interconnectivity. Wired networks can utilize any adequate cabling and topology.

In one embodiment of the present invention, the interconnect system provides interfaces for the connection of gateways for expansibility to other lighting systems and possible communication with either the same or another type of network. The interconnect system can optionally comprise interfaces to other networks which are not exclusively dedicated to lighting control, for example, gateways to a building management system or the like.

The present invention provides a solid-state lighting network interconnect system specified in accordance with the Open Systems Interconnection Reference Model (OSI model) which is herein incorporated by reference. The OSI model utilizes a hierarchical description for communications and computer network protocol design. Detailed information about the OSI model is readily available and widely known.

The OSI model describes interconnect systems in a seven layer hierarchical model: Layer 7, also called the application layer, specifies network applications such as file transfer, terminal emulation, email etc. Layer 6, also called the presentation layer, specifies how to represent or encode data. Layer 5, also called the session layer, defines how communication sessions are established between network devices. Layer 4, also called the transport layer, specifies data flow control, error correction and data recovery. Layer 3, also called the network layer, specifies how data is organized into chunks or packets and also defines address assignment and package forwarding. Layer 2, also called the data link layer, defines frame format and error checking. Layer 1, also called the physical layer, defines the physical implementation of the network including the medium, for example, wire or wireless, which is used for data exchange.

### Solid-State Lighting Device

In one embodiment of the present invention, a node is a solid-state lighting device. Examples of solid-state lighting devices include solid-state luminaires or fixtures. A solid-state lighting device can comprise one or more light-emitting elements or a one or more groups of light-emitting elements, wherein each group can comprise one or more light-emitting elements. Each group can comprise light-emitting elements of the same nominal chromaticities, for example chromaticities can be in the red, green, blue, amber, purple or white range etc. When differently coloured light-emitting elements emit light which is adequately mixed, controlling colour and intensity of the mixed light is then a matter of controlling the amount of light provided by each of the same colour light-emitting elements. The colour of the mixed light can thus be controlled within a range of colours defined by the colour gamut of the illumination device. The colour gamut is defined by the different colour light-emitting elements within the illumination device subject to achievable operating conditions.

Current drivers are coupled to the arrays and are configured to supply current to each array of light-emitting elements separately. The current drivers control the amount of drive current supplied to and hence the amount of light emitted by the light-emitting elements. The current drivers are configured to regulate the supply of current to each array separately so as to control the luminous flux and chromaticity of the combined mixed light. A power supply coupled to the current drivers can provide electrical power.

A lighting device controller is coupled to current drivers and the controller is configured to independently adjust each average forward current by separately adjusting the duty cycles of each of current drivers. The controller transmits control signals to each of current drivers, wherein the control signals determine the current generated by the current drivers which is supplied to each array of light-emitting elements. Variations of the drive current, which are intended to control the time-averaged amount of light emitted by the light-emitting elements, are desirably fast enough to avoid perceivable flicker.

A solid-state lighting network protocol for the solid-state lighting network specifies how to control the operating conditions of the lighting devices in the lighting network. The message format defines how the lighting devices can be addressed. Different embodiments of the present invention may address lighting devices in different ways.

In one embodiment for example, messages can include an address field. The address field can contain address data encoding an address referring to a specific node. One or more nodes in the network may share the same address. Alternatively, a sequence of multiplexed messages can be sent to all nodes on, for example, a bus, and the position of each message within the sequence determines what node the message is designated for. It is then up to the node to extract the right message(s) from the sequence. Further, certain network topologies permit the master controller(s) to communicate with each one of the nodes separately via a dedicated physical connection that is not shared with other nodes such as in a star topology, for example. Interconnect systems according to the present invention may therefore utilize different protocols which either include or exclude address data in the message format.

### Lighting Device Controller

A lighting device comprises an internal lighting device controller. A lighting device controller can be a device having a programmable central processing unit (CPU) (such as a microcontroller) and peripheral input/output devices (such as analog-to-digital converters) to monitor parameters from devices that are coupled to the controller. These input/output devices can also permit the central processing unit of the controller to communicate with and control the devices coupled to the controller, such as LED drivers for example. The controller can optionally include memory such as one or more storage media including volatile and non-volatile computer memory such as RAM, PROM, EPROM, and EEPROM, floppy disks, compact disks, optical disks, magnetic tape, or the like, wherein control programs (such as software, microcode or firmware etc) for monitoring or controlling the devices coupled to the controller are stored and executed by the CPU. Optionally, the controller also provides a means for converting user-specified operating requirements into control signals to control the peripheral devices coupled to the controller. The controller can be configured with a user interface to receive data from a keyboard, for example. Furthermore, the controller can be operatively coupled, either directly or indirectly, via adequate interfaces with the interconnect system.

### Master Controller

The master controller can generate commands according to a solid-state lighting network protocol and submit the commands via the interconnect system to a lighting device, wherein the lighting device controller can receive these commands from the master controller(s).

The master controller can comprise a form of one or more digital or analog processing units such as a CPU together with memory as would be readily understood by a person skilled in the art. A sequence of instructions, for example a solid-state lighting network protocol can be stored in the memory for access by the master controller. The master controller may be part of a control console or a computer system, for example.

In one embodiment, the master controller(s) generate predetermined sequences of commands or they generate commands according to information received from a user via a user interface, for example, which is coupled thereto.

### Solid-State Lighting Network Protocol

The solid state-lighting network protocol includes the following components at OSI model layers 1, 2, 6 and 7. Layer 1 can be an EIA/TIA RS-485 multi-drop network with a single master or other hardware implementation as would be readily understood by someone skilled in the art. Layer 2 can be an industry-standard universal synchronous microcontroller asynchronous receiver transmitter (USART), or the like. In one embodiment, the communication format can be one start bit, eight data bits and one stop bit, for example and the communication rate may be between about 19.2 kbps and about 250 kbps, for example. As would be known to a worker skilled in the art, the solid-state lighting network protocol can also be implemented using interconnect systems with other layer 1 to layer 5 components.

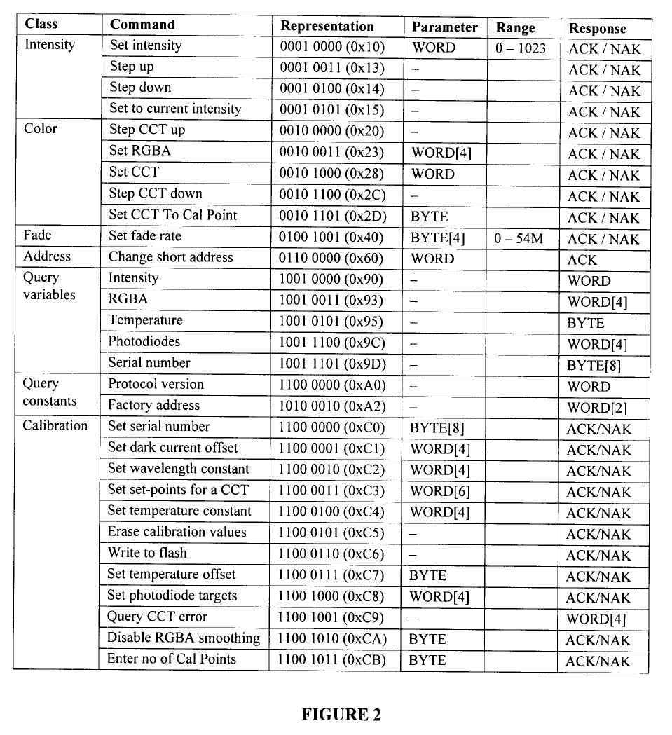

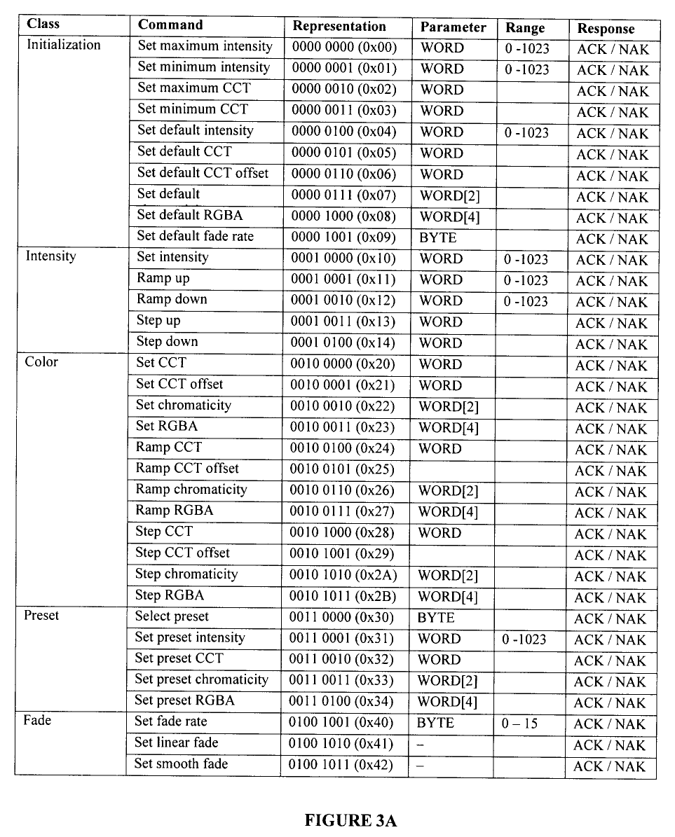

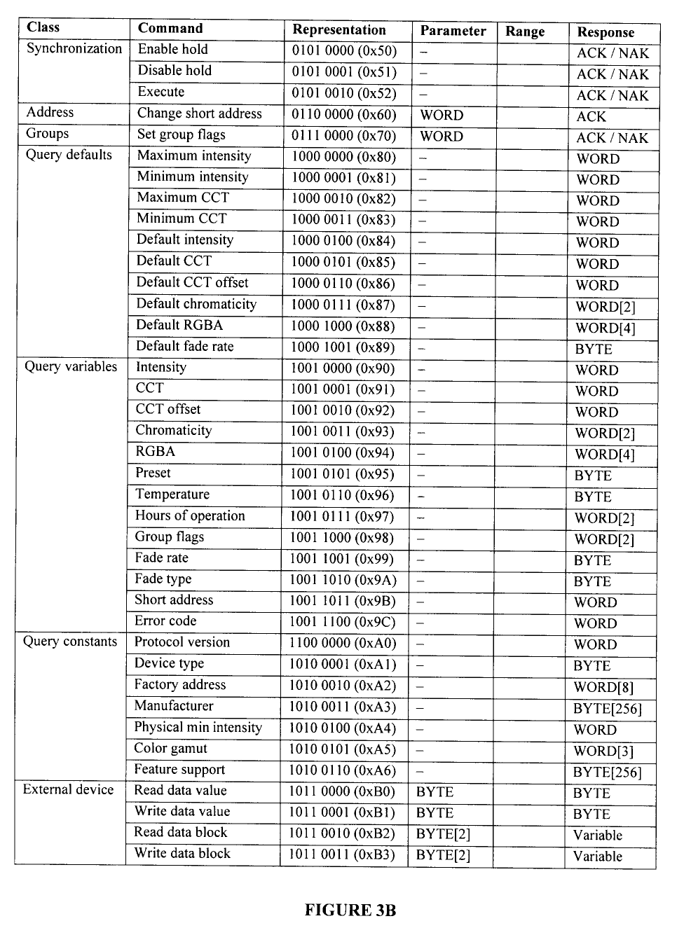

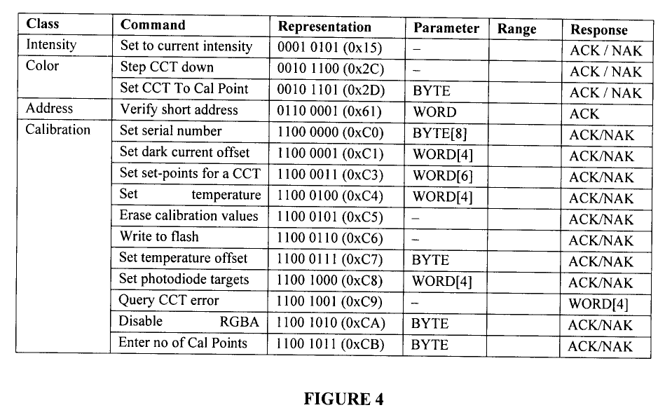

Layer 6 specifies how the commands of the lighting network protocol are encoded. Embodiments of solid-state lighting network protocols are described below and in FIG. 2, FIGS. 3A and 3B and FIG. 4.

The application layer, layer 7, of the solid-state lighting network comprises a command set which can be tailored to meet the requirements of solid-state lighting network control. Different embodiments of command sets according to the present invention are described below. Each command set can provide at least a portion of the required information to effectively control a solid-state lighting device regarding a certain functionality.

In one embodiment, the solid-state lighting command set can optionally provide commands for monitoring and control of external devices such as timers, daylight or occupancy sensors, or other devices for example. The solid-state lighting network protocol can include commands for the control of external devices, for example, elements in building access management systems and the like. A solid-state lighting command may be used to control non-lighting functions of a luminaire or functions of non-luminaire devices. Such functions or devices can be configured and operated using their own designated address or by simply sharing an address with a luminaire.

The following examples describe and illustrate different aspects of embodiments of the present invention having direct regard to embodiments wherein a node is a solid-state lighting device. FIG. 2, FIGS. 3A and 3B and FIG. 4 illustrate tables listing command classes and commands according to embodiments of the present invention. Each command class comprises the listed commands. As described above, commands can be encoded in messages which may or may not bear address data. As illustrated in the FIGS. 2, 3A, 3B and 4 each command can be encoded as specified by the binary and hexadecimal numbers in the representation column. It is noted that the encodings are exemplary only and that command sets of different embodiments can be encoded in other ways, as would be readily understood by a worker skilled in the art.

In one embodiment, commands can comprise one or more parameters representing data such as one or more operating conditions. The operating conditions are encoded in numbers which may vary within specified ranges. Example ranges are specified in the parameter column in the tables illustrated in FIGS. 2, 3A, 3B and 4. A parameter can comprise data units of one or more words indicated by WORD or BYTE. WORD[x] or BYTE[x] indicates that the respective parameter comprises x WORDS or x BYTES. A BYTE comprises eight bits and a WORD can comprise 16 bits or other adequate number of bits that is suitable to encode a desired data range or parameter values. The last column of the tables provided in FIGS. 2, 3A, 3B and 4 indicates the response encoded in a subsequent signal which is to be returned by the originally addressed solid-state lighting device. Nodes or solid-state lighting devices can return acknowledge (ACK) signals indicating merely that the solid-state lighting device has received or recognized the command and a solid-state lighting device can also return a parameter which can be encoded in a number of BYTEs or WORDs. Each command is submitted to solid-state lighting devices at specific addresses, however two or more solid-state lighting devices can share the same address.

FIG. 2 illustrates command classes and commands according to an embodiment of the present invention. The commands which are listed in the table illustrated in FIG. 2 are specified in detail below.

FIGS. 3A and 3B illustrate command classes and commands according to an embodiment of the present invention. This command set comprises an extension of the command set of the first embodiment. It is noted that the command set of the second embodiment includes additional commands. It is also noted that the same types of commands can have different parameter ranges, for example, the intensity specific commands in example 1 provide ten bit intensity resolution control with encoded intensities ranging from 0 to 1023, whereas in example 2 provide twelve bit intensity resolution control with encoded intensities ranging from values 0 to 4095 is provided. The commands which are listed in the table illustrated in FIGS. 3A and 3B are specified below.

FIG. 4 illustrates a subset of command classes and commands according to an embodiment that can be used in combination with the commands already presented in example 2. The command set according to example 3 comprises the commands listed in the table illustrated in FIG. 4 and includes the commands of as presented in example 2. The commands which are listed in the table illustrated in FIG. 4 are specified below.

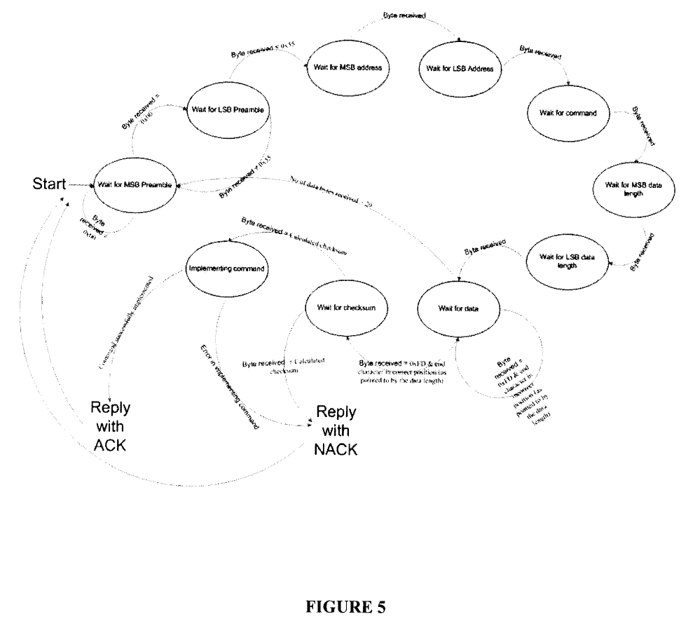

According to one embodiment of the present invention, FIG. 5 illustrates a state machine for processing commands according to the commands as presented in FIGS. 2, 3A, 3B and 4.

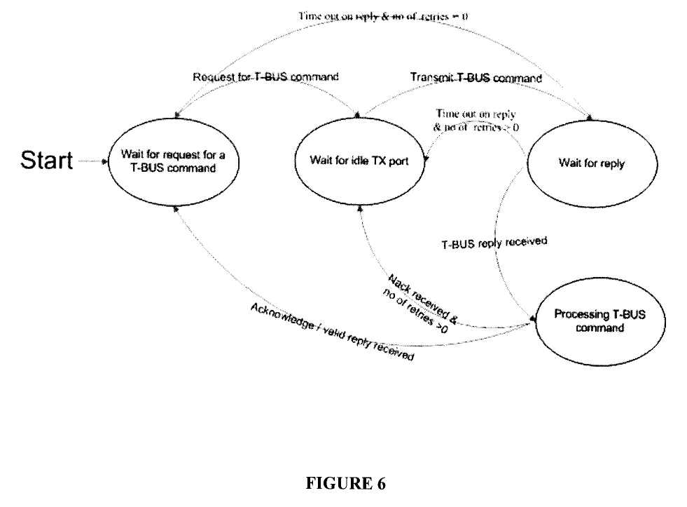

According to one embodiment of the present invention, FIG. 6 illustrates a state machine for processing transmitted commands according to the commands as presented in FIGS. 2, 3A, 3B and 4.

### List of Commands

### Calibration Commands

Set serial number assigns a serial number to a luminaire dependent on the data included in the command.

Set dark current offset sets photodiode readings for red, green, blue and amber when the light output from the luminaire is switched off.

Set wavelength constant sets the dominant wavelength values for the red, green and amber light-emitting elements, expressed in nanometers.

Set set-points for a CCT sets and stores target photodiode settings for red, green, blue and amber for a given correlated color temperature (CCT) and intensity.

Set temperature constant sets calibrated temperature constants for red, green, blue and amber.

Erase calibration values erases a preset number of calibration values.

Write to flash saves calibration values and current settings in flash.

Set temperature offset This command is used only in temperature calibration. At the start of calibration, when the luminaire is at a low temperature, the offset is set to the current temperature to eliminate the effects of temperature constants. As the luminaire heats up, the temperature constants are adjusted to give the same CCT as at the start of calibration.

Set photodiode targets sets photodiode target settings for red, green, blue and amber.

Query CCT error queries the difference between the target photodiode value and the current photodiode value.

Disable RGBA smoothing enables or disables the DMX mode. When DMX is enabled, delay is introduced between color changes.

Enter number of calibration points set the permissible number of calibration points.

### Initialization Commands

Initialization commands initialize certain operational parameters of a luminaire without directly affecting the light output of the luminaire. The initialization commands are:

Set maximum intensity directs the addressed device to store the value specified in the parameter as its maximum intensity, relative to full luminaire intensity.

Set minimum intensity directs the addressed device to store the value specified in the parameter as its minimum intensity, relative to full luminaire intensity.

Set maximum correlated color temperature (CCT) directs the addressed device to store the value specified in the parameter as its maximum correlated color temperature (CCT), expressed in microreciprocal Kelvin (mireks).

Set minimum CCT directs the addressed device to store the value specified in the parameter as its minimum CCT, expressed in mireks

Set default intensity directs the addressed device to store the value specified in the parameter as its default intensity relative to full luminaire intensity.

Set default CCT directs the addressed device to store the value specified in the parameter as its default CCT, expressed in mireks.

Set default CCT offset directs the addressed device to store the value specified in the parameter as its default CCT offset, wherein the CCT offset is an incremental change in chromaticity in a direction perpendicular to the Planckian locus in the CIE (Commission Internationale de l'Eclairage) 1960 Uniform Colour Space (UCS), expressed in mireks relative to the corresponding default CCT.

Set default chromaticity directs the addressed device to store the value specified in the parameter as its default chromaticity, expressed in CIE 1960 UCS uv coordinates.

Set default red, green, blue, amber (RGBA) directs the addressed device to store the values specified in the parameter as its red, green, blue and amber default intensities, relative to full luminaire intensity for the specified colors.

Set default fade rate directs the addressed device to store the default fade rate as specified in the parameter.

### Intensity Commands

Intensity commands are intended to directly affect the light output of the addressed one or more luminaires. The intensity commands are:

Set intensity directs the addressed device to generate the intensity specified in the parameter, relative to full luminaire intensity.

Ramp up directs the addressed device to smoothly increase the current intensity by the amount specified in the parameter according to the current ramping function and fade rate, relative to full luminaire intensity.

Ramp down directs the addressed device to smoothly decrease the current intensity by the amount specified in the parameter according to the current ramping function and fade rate, relative to full luminaire intensity.

Step up directs the addressed device to immediately increase the current intensity by the amount indicated in the parameter, relative to full luminaire intensity.

Step down directs the addressed device to immediately decrease the current intensity by the amount indicated in the parameter, relative to full luminaire intensity.

Set to current intensity stops fading and sets the output intensity to the current intensity.

### Color Commands

Color commands are intended to directly affect the color of the light generated by a luminaire. The color commands are:

Set CCT directs the addressed device to generate white light with the CCT as specified in the parameter, expressed in mireks.

Set CCT offset directs the addressed device to generate white light with a CCT offset as specified in the parameter, expressed in mireks relative to the current CCT.

Set chromaticity directs the addressed device to generate white light with the chromaticity as specified in the parameter, expressed in CIE 1960 UCS uv coordinates, while maintaining the current intensity.

Set RGBA directs the addressed device to generate light according to the red, green, blue and amber intensity values specified in the parameter, relative to full luminaire intensity for the specified colors.

Ramp CCT directs the addressed device to smoothly change the CCT by the amount specified in the parameter, expressed in mireks, according to the current ramping function and fade rate.

Ramp CCT offset directs the addressed device to smoothly change the current chromaticity to the chromaticity indicated by the CCT offset value specified in the parameter, expressed in mireks, according to the current ramping function and fade rate.

Ramp chromaticity directs the addressed device to smoothly change the chromaticity of the generated light by the amount specified by the values in the parameter expressed in CIE 1960 UCS uv coordinates, according to current ramping function and fade rate, while maintaining the current intensity.

Ramp RGBA directs the addressed device to smoothly change the red, green, blue and amber intensity values as specified in the parameter, relative to full luminaire intensity for the specified colors, according to a predefined ramping function.

Step CCT directs the addressed device to immediately change the CCT by the amount specified in the parameter, expressed in mireks.

Step CCT offset directs the addressed device to immediately change the current chromaticity to the chromaticity indicated by the CCT offset value specified in the parameter, expressed in mireks.

Step chromaticity directs the addressed device to immediately change the chromaticity of the generated light by the amount specified by the values in the parameter expressed in CIE 1960 UCS uv coordinates.

Step RGBA directs the addressed device to immediately change the red, green, blue and amber intensity values as specified in the parameter, relative to full luminaire intensity for the specified colors.

Step CCT down decreases the CCT to the next calibrated value, except when the CCT is at its minimum calibrated value.

Set CCT To Cal Point sets the output to a calibration point determined by the data included in the command.

### Preset Commands

In addition to the default operational parameters, each luminaire has a 32-element array of user-defined operational parameters. The preset commands are:

Select preset directs the addressed device to generate the preset intensity and color according to the preset array element specified by the parameter.

Set preset intensity directs the addressed device to store the value specified in the parameter as the currently selected preset intensity, relative to full luminaire intensity.

Set preset CCT directs the addressed device to store the value specified in the parameter as the currently selected preset CCT, expressed in microreciprocal Kelvin (mireks). This command overrides the action of previous Set preset chromaticity and Set preset RGBA commands for the currently selected preset.

Set preset chromaticity directs the addressed device to store the value specified in the parameter as the currently selected preset chromaticity, expressed in CIE 1960 UCS uv coordinates. This command overrides the action of previous Set preset CCT and Set preset RGBA commands for the currently selected preset.

Set preset RGBA directs the addressed device to store the values specified in the parameter as the currently selected red, green, blue and amber preset intensities, relative to full luminaire intensity for the specified colors. This command overrides the action of previous Set preset chromaticity and Set preset chromaticity commands for the currently selected preset.

### Fade Commands

Fade commands are intended to control transitions between operational states of a luminaire. The luminaire controller can fade (ramp) between the current intensity or color and a user-specified intensity or color according to different predetermined ramp functions. Fading can be controlled from within the luminaire, which can make the luminaire more complex, or alternatively from outside via the network but at the expense of higher network traffic.

Set fade rate instructs the addressed device to set a fade rate. In an embodiment of the present invention the fade rate is set to, for example:

$$F = \frac{506}{\sqrt{{2}^{x}}} steps / sec$$

where x is the fade time parameter according to International Electrotechnical Commission (IEC) standard 50929:2003 Section E.4.3.3.2. 1, Command 47. Set fade rate does not affect the light generated by the addressed device but it instructs the device to store the fade rate specified in the parameter.

Set linear fade sets a constant fade rate. The luminaire controller may optionally fade between the current intensity or color and a user-specified intensity or color at a fixed rate as specified by the fade rate.

Set smooth fade sets a variable fade rate that has a sigmoid fade rate versus time profile. An embodiment of a smooth intensity or color change can follow

$$I ( t ) = \frac{1 - cos ( π * t )}{2 T} * ( {I}_{2} - {I}_{1} ) + {I}_{1} ∀ t ∈ [ 0 , 1 ] , with T = ( {I}_{2} - {I}_{1} ) * x ,$$

where t is time, T is the total transient time, I₁ is the initial intensity at the beginning of the fade and I₂ is the desired intensity of after the fade is completed, and x is the fade time parameter according to IEC 50929:2003 Section E.4.3.3.2.1, command 47. A good approximation for I(t) can be implemented in fixed-point arithmetic using a polynomial approximation

$$based on \frac{1 - cos ( z )}{2} ≅ \{ \begin{matrix}\frac{{z}^{2}}{4} - \frac{{z}^{4}}{52} , & 0 \leq z < π / 2 \\ 1 - \frac{{( π - z )}^{2}}{4} + \frac{{( π - z )}^{4}}{52} , & π / 2 < z \leq π\end{matrix} .$$

### Synchronization Commands

Synchronization commands instruct the addressed device to disable execution of commands while enabling the receipt and queuing of a subsequent command. The synchronization commands are:

Enable hold instructs the addressed device to delay execution of a subsequent command until it receives an Execute command.

Disable hold instructs the addressed device to execute subsequent commands immediately.

Execute instructs the addressed device to execute a preceding command if an Enable Hold command has been previously received without a subsequent Disable hold command.

### Address Commands

A luminaire has a factory-assigned 64-bit address and a user-defined 16-bit short address. The luminaire will respond to both its factory-assigned address and its short address. Address commands instruct the addressed device to update its short address.

Change short address instructs the addressed device to set its short address to the specified parameter.

A luminaire may be assigned to one or more of sixteen groups, wherein all luminaires assigned to a group respond in unison to a command with the appropriate group address.

Set group flags instructs the addressed device to set its group flags according to the specified parameter.

Verify short address verifies whether the short address is correct.

### Query Defaults Commands

Query defaults commands instruct the addressed device to return the respective settings. The settings can be specified by using a respective one of the initialization commands. Each query command has a respective counterpart initialization command as described above. A query command instructs the addressed device to return the value of the queried setting. The query commands are:

Query maximum intensity instructs the addressed device to return the default maximum intensity, relative to full luminaire intensity.

Query minimum intensity instructs the addressed device to return the default minimum intensity, relative to full luminaire intensity.

Query maximum CCT instructs the addressed device to return the default maximum CCT, expressed in mireks.

Query minimum CCT instructs the addressed device to return the default minimum CCT, expressed in mireks.

Query default intensity instructs the addressed device to return the default intensity, relative to full luminaire intensity.

Query default CCT instructs the addressed device to return the default CCT, expressed in mireks.

Query default CCT offset instructs the addressed device to return the default CCT offset, expressed in mireks relative to the corresponding default CCT.

Query default chromaticity instructs the addressed device to return the default chromaticity, expressed in CIE 1960 UCS uv coordinates.

Query default RGBA instructs the addressed device to return red, green, blue and amber default intensities, relative to full luminaire intensity for the specified colors.

Query default fade rate instructs the addressed device to return the default fade rate.

### Query Variables

Query variables commands query variable or non-default settings of an addressed device. The query variables commands are similar to the query defaults commands and follow the same sequence of steps. The query variables commands are:

Query intensity instructs the addressed device to return the current intensity, relative to full luminaire intensity.

Query CCT instructs the addressed device to return the current CCT, expressed in mireks.

Query CCT offset instructs the addressed device to return the current CCT offset, expressed in mireks, relative to the corresponding current CCT.

Query chromaticity instructs the addressed device to return the current chromaticity, expressed in CIE 1960 UCS uv coordinates.

Query RGBA instructs the addressed device to return the current red, green, blue and amber intensity values, relative to full luminaire intensity for the specified colors.

Query preset instructs the addressed device to return the current preset array index.

Query temperature instructs the addressed device to return the current luminaire temperature.

Query hours of operation queries accrued hours of operation from the addressed device. The accrued hours of operation can be the total amount of hours since the last service of the device, for example, the amount of hours since the installation of a luminaire, or the amount of operating hours or hours the luminaire has not been switched off since installation.

Query group flags instructs the addressed device to return the current group flags.

Query fade rate instructs the addressed device to return the current fade rate.

Query fade type instructs the addressed device to return the current fade type.

Query short address instructs the addressed device to return the current short address.

Query error code instructs the addressed device to return the current device error code.

### Query Constant Commands

Query constant commands query values of predetermined parameters as listed below. The query constants commands are:

Query protocol version queries what version of the solid-state lighting network protocol the addressed device is compatible with.

Query device type queries an identifier of the addressed device which can indicate the category of the device. The devices in the solid-state lighting network can be classified into categories such as luminaires and external devices. Note that the devices can be categorized by any other adequate classification scheme.

Query factory address instructs the addressed device to return its factory-assigned 64-bit address.

Query manufacturer instructs the addressed device to return manufacturer-specific information.

Query physical minimum intensity instructs the addressed device to return the minimum non-zero intensity of the luminaire, relative to full luminaire intensity.

Query color gamut instructs the addressed device to return the color gamut of the luminaire, expressed in CIE 1960 UCS uv coordinates. The gamut defines the range of colors that the luminaire is able to generate.

Query feature support instructs the addressed device to return information indicating the capabilities of the device.

### External Device Commands

External Device commands can communicate information with and control external devices. The data format and the information represented in the data are device-specific and can vary among devices. The parameter format can be as specified in the table which is illustrated in FIG. 3A and FIG. 3B.

Read data value instructs the addressed device to read a data value from an array of data values, indexed according to the specified parameter.

Write data value instructs the addressed device to write a data value to an array of data values, indexed according to the specified parameter.

Read data block instructs the addressed device to read a block of data from the device.

Write data block instructs the addressed device to write a block of data to the device.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

The disclosure of all patents, publications, including published patent applications, and database entries referenced in this specification are specifically incorporated by reference in their entirety to the same extent as if each such individual patent, publication, and database entry were specifically and individually indicated to be incorporated by reference.

1. A solid-state lighting network system comprising:
(a) at least one master controller;
(b) at least one node;
(c) an interconnect system operatively coupling the at least one master controller to the at least one node;
wherein the one or more nodes and the one or more master controllers are configured to generate messages and exchange the messages via the interconnect system, each message comprising a number of parameters and at least one message code.

2. The solid-state lighting network system according to claim 1, wherein the interconnect system comprises a RS-485 multi-drop network.

3. (canceled)

4. The solid-state lighting network system according to claim 1, wherein the number of parameters is predetermined based on the at least one message code.

5. (canceled)

6. The solid-state lighting network system according to claim 1, wherein the at least one message code indicates a command designated for the at least one node.

7. The solid-state lighting network system according to claim 1, wherein the at least one message code indicates a response from the at least one node.

8. The solid-state lighting network system according to claim 1, wherein the message comprises one or more node addresses.

9. A solid-state lighting network control method comprising: a) generating a plurality of messages, each message comprising a number of parameters and at least one message code; b) transmitting the messages via an interconnect system.

10. (canceled)

11. The solid-state lighting network control method according to claim 9, wherein the number of parameters is predetermined based on the at least one message code.

12. The solid-state lighting network control method according to claim 9, wherein for each message the number of parameters is indicated in the message.

13. The solid-state lighting network control method according to claim 9, wherein the interconnect system interconnects one or more master controllers and one or more nodes.

14. The solid-state lighting network control method according to claim 13, wherein the messages are generated by the one or more master controllers and the one or more nodes.

15. The solid-state lighting network control method according to claim 14, wherein the at least one message code indicates one ore more commands to the nodes and/or one or more responses from the nodes.

16. The solid-state lighting network control method according to claim 8, wherein each message comprises one or more node addresses.
